(19) United States
(12) Patent Application Publication
(10) Pub. No.: US 2013/0066875 A1
(43) Pub. Date: Mar. 14, 2013

(54) Method for Segmenting Users of Mobile Internet

(71) Applicants: Jacques Combet, Levallois-Perret (FR); Gerard Hermet, Paris (FR)

(72) Inventors: Jacques Combet, Levallois-Perret (FR); Gerard Hermet, Paris (FR)

(21) Appl. No.: 13/230,605

(22) Filed: Sep. 12, 2011

(51) Int. Cl. G06F 15/173; G06F 17/30

(52) U.S. Cl. 707/740; 709/224; 707/E17.005; 707/E17.09

(57) ABSTRACT

Domains supported by websites accessible to mobile network users over the Internet are classified into pre-defined categories based on domain content. A network intelligence solution (NIS) taps a stream of IP (Internet Protocol) packets traversing a node in the network between mobile equipment employed by network users and remote web servers. The NIS performs deep packet inspection to aggregate Internet usage so that a distribution of frequency of access by the network users to each of the classified domains may be calculated. Clusters encompassing one or more of the categories are specified based, at least in part, on the access frequency distribution. Each network user is assigned to one or more clusters based at least on observations of the user's frequency of access to the classified domains. Clusters are specified to meet a target homogeneity of access frequency for each encompassed category and further to meet a target heterogeneity across clusters.

### CROSS-REFERENCE TO RELATED APPLICATIONS

This application is related to U.S. patent applications respectively entitled “System and Method for Automated Classification of Web Pages and Domains”, “System and Method for Relating Internet Usage with Mobile Equipment”, and “Analyzing Internet Traffic by Extrapolating Socio-Demographic information from a Panel” each being filed concurrently herewith and owned by the assignee of the present invention, and the disclosure of which is incorporated by reference herein in its entirety.

### BACKGROUND

Communication networks provide services and features to users that are increasingly important and relied upon to meet the demand for connectivity to the world at large. Communication networks, whether voice or data, are designed in view of a multitude of variables that must be carefully weighed and balanced in order to provide reliable and cost effective offerings that are often essential to maintain customer satisfaction. Accordingly, being able to analyze network activities and manage information gained from the accurate measurement of network traffic characteristics is generally important to ensure successful network operations.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Domains supported by websites accessible to mobile network users over the Internet are classified into pre-defined categories based on content. A network intelligence solution (NIS) is arranged to tap a stream of IP (Internet Protocol) packets traversing a node in the network between mobile equipment employed by network users and one or more remote web servers. The NIS performs deep packet inspection to aggregate Internet usage so that a distribution of frequency of access by the network users to each of the classified domains may be calculated. Clusters encompassing one or more of the categories are specified based, at least in part, on the access frequency distribution. Each network user is assigned to one or more clusters based at least on observations of the user's frequency of access to the classified domains. Clusters are specified to meet a target homogeneity of access frequency for each encompassed category and further to meet a target heterogeneity across clusters.

In various illustrative examples, network users may be assigned to clusters in view of criteria in addition to the observed frequency of access to classified domains. Such criteria may include time of access and the type and characteristics of the mobile equipment used for access. Internet usage may be aggregated, clusters specified, and users assigned in iterative manner over a timeline so that a time series of cluster assignments can be generated for trend reporting, for example.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative mobile communications network environment that facilitates access to resources by users of mobile equipment and with which the present system and method may be implemented;

FIG. 2 shows an illustrative web browsing session which utilizes a request-response communication protocol;

FIG. 3 shows an illustrative NIS that may be located in a mobile communications network or node thereof and which processes information from traffic flowing in the network to measure Internet usage;

FIG. 4 shows an illustrative deep packet inspection machine that may be utilized to perform measurements of Internet usage;

FIG. 5 shows domains accessed from sites by network users being classified by content into various pre-defined categories;

FIG. 6 shows Internet access by network users being aggregated over a given time interval to generate a distribution over the classified domains;

FIG. 7 shows assignment of each of the network users to one or more clusters in which the assignment is based at least on the user's frequency of access to the classified domains;

FIG. 8 shows the conditions to be satisfied to instantiate a cluster including internal homogeneity within a cluster and external heterogeneity across clusters;

FIG. 9 shows the assignment of network users to clusters being performed at multiple times along a timeline;

FIG. 10 shows application of an illustrative extraction engine that uses the TAC (Type Allocation Code) to identify information pertaining to the mobile equipment utilized in the mobile communications network environment;

FIG. 11 shows use of an illustrative analysis engine for performing analyses of data including internet usage measurements and mobile equipment information; and

FIG. 12 is a flowchart of an illustrative method for segmenting users of mobile Internet.

Like reference numerals indicate like elements in the drawings. Unless otherwise indicated, elements are not drawn to scale.

### DETAILED DESCRIPTION

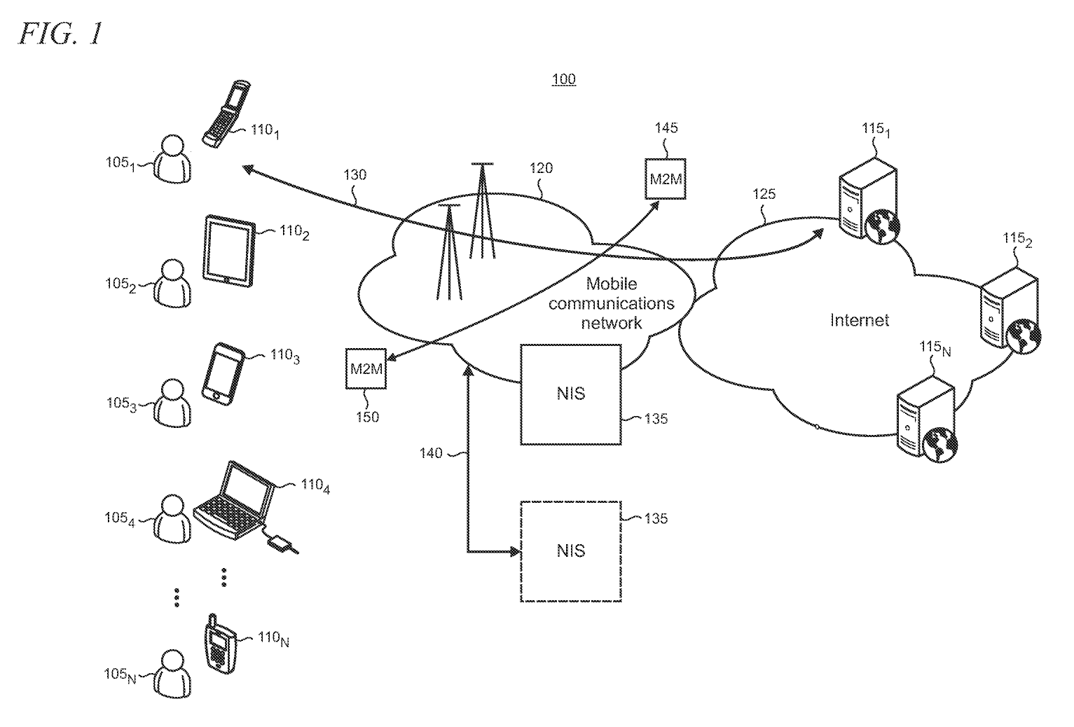

FIG. 1 shows an illustrative mobile communications network environment 100 that facilitates access to resources by users 105_{1, 2 . . . N} of mobile equipment 110_{1, 2 . . . N} and with which the present arrangement for segmenting mobile Internet users may be implemented. In this example, the resources are web-based resources that are provided from various websites 115_{1, 2 . . . N}. Access is implemented, in this illustrative example, via a mobile communications network 120 that is operatively connected to the websites 115 via the Internet 125. It is emphasized that the present system and method are not necessarily limited in applicability to mobile communications network implementations and that other network types that facilitate access to the World Wide Web including local area and wide area networks, PSTNs (Public Switched Telephone Networks), and the like that may incorporate both wired and wireless infrastructure may be utilized in some implementations. In this illustrative example, the mobile communications network 120 may be arranged using one of a variety of alternative networking standards such as GPRS (General Packet Radio Service), UMTS (Universal Mobile Telecommunications System), GSM/EDGE (Global System for Mobile Communications/Enhanced Data rates for GSM Evolution), CDMA (Code Division Multiple Access), CDMA2000, or other 2.5G, 3G, 3G+, or 4G (2.5^{th} generation, 3^{rd} generation, 3^{rd} generation plus, and 4^{th} generation, respectively) wireless standards, and the like.

The mobile equipment 110 may include any of a variety of conventional electronic devices or information appliances that are typically portable and battery-operated and which may facilitate communications using voice and data. For example, the mobile equipment 110 can include mobile phones (e.g., non-smart phones having a minimum of 2.5G capability), e-mail appliances, smart phones, PDAs (personal digital assistants), ultra-mobile PCs (personal computers), tablet devices, tablet PCs, handheld game devices, digital media players, digital cameras including still and video cameras, GPS (global positioning system) navigation devices, pagers, electronic devices that are tethered or otherwise coupled to a network access device (e.g., wireless data card, dongle, modem, or other device having similar functionality to provide wireless Internet access to the electronic device) or devices which combine one or more of the features of such devices. Typically, the mobile equipment 110 will include various capabilities such as the provisioning of a user interface that enables a user 105 to access the Internet 125 and browse and selectively interact with domains that are supported by the websites 115, as representatively indicated by reference numeral 130.

The network environment 100 may also support communications among machine-to-machine (M2M) equipment and facilitate the utilization of various M2Mapplications. In this case, various instances of peer M2M equipment (representatively indicated by reference numerals 145 and 150) or other infrastructure supporting one or more M2Mapplications will send and receive traffic over the mobile communications network 120 and/or the Internet 125. In addition to accessing traffic on the mobile communications network 120 in order to relate Internet usage to mobile equipment, the present arrangement may also be adapted to access M2M traffic for the purposes of relating utilization of network resources to M2M equipment. Accordingly, while the description that follows is applicable to an illustrative example in which Internet usage is related to mobile equipment, those skilled in the art will appreciate that a similar methodology may be used when relating M2M equipment to network resource use.

A NIS 135 is also provided in the environment 100 and operatively coupled to the mobile communications network 120, or to a network node thereof (not shown) in order to access traffic that flows through the network or node. In alternative implementations, the NIS 135 can be remotely located from the mobile communications network 120 and be operatively coupled to the network, or network node, using a communications link 140 over which a remote access protocol is implemented. In some instances of remote operation, a buffer (not shown) may be disposed in the mobile communications network 120 for locally buffering data that is accessed from the remotely located NIS.

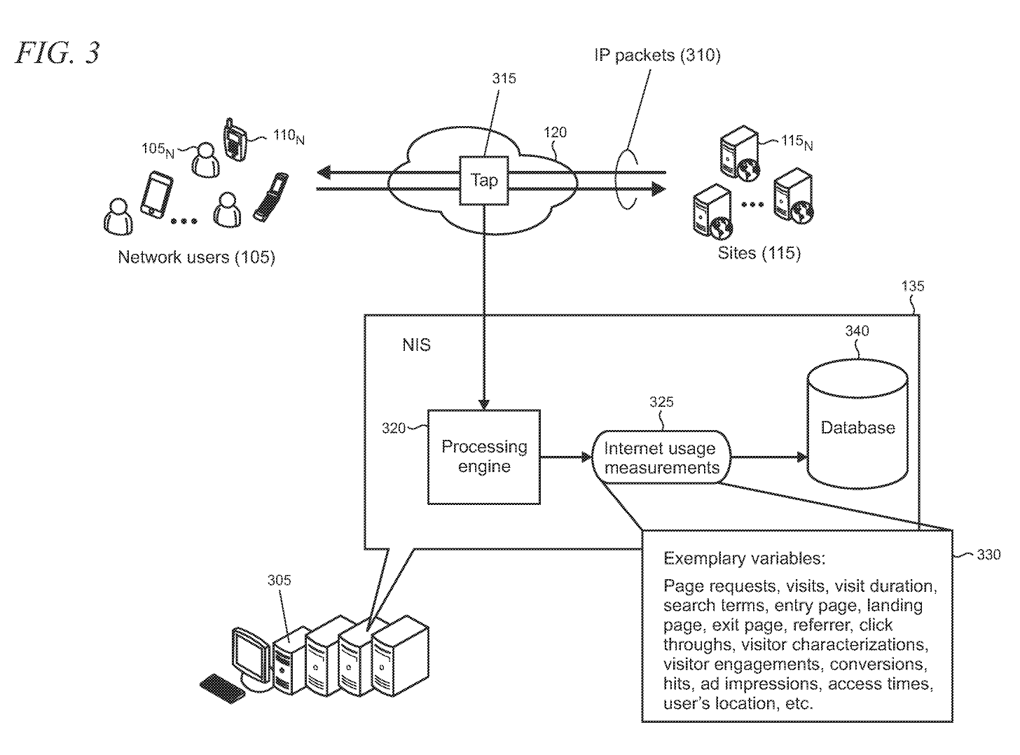

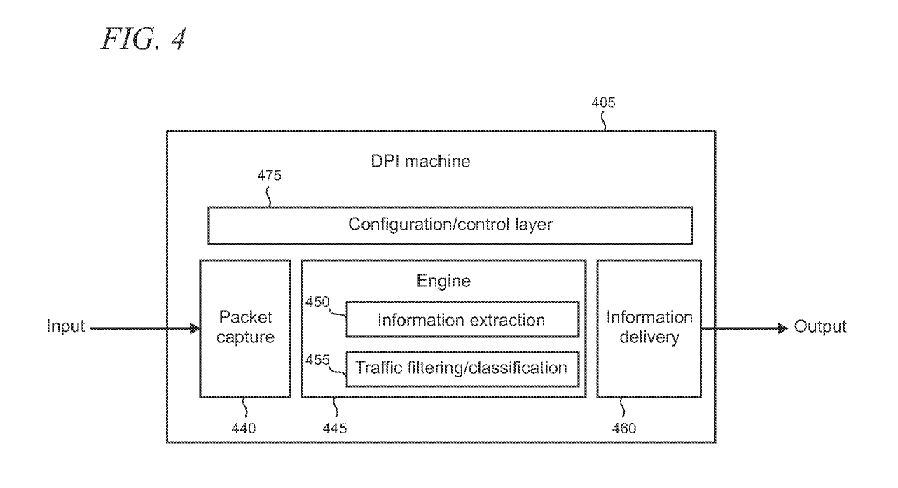

It is noted that performing network traffic analysis from a network-centric viewpoint can be particularly advantageous in many scenarios. For example, attempting to collect information at the mobile equipment 110 can be problematic because such devices are often configured to utilize thin client applications and typically feature streamlined capabilities such as reduced processing power, memory, and storage compared to other devices that are commonly used for web browsing such as PCs. In addition, collecting data at the network advantageously enables data to be aggregated across a number of instances of mobile equipment 110, and further reduces intrusiveness and the potential for violation of personal privacy that could result from the installation of monitoring software at the client. The NIS 135 is described in more detail in the text accompanying FIGS. 3 and 4 below.

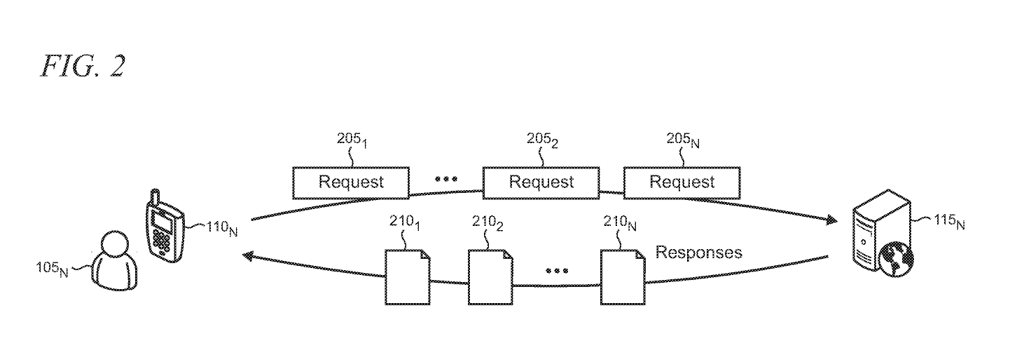

FIG. 2 shows an illustrative web browsing session which utilizes a protocol such as HTTP (HyperText Transfer Protocol) or SIP (Session Initiation Protocol). In this particular illustrative example, the web browsing session utilizes HTTP which is commonly referred to as a request-response protocol that is commonly utilized to access websites. Access typically consists of file requests 205_{1, 2 . . . N} for objects such as pages from a domain using a browser application executing on the mobile equipment 110 to a website 115 and corresponding responses 210_{1, 2 . . . N} from the domain's website server. Thus, at a high level, the user 105 interacts with a browser to request, for example, a URL (Uniform Resource Locator) to identify a site of interest, then the browser requests the page from the website 115. When receiving the page, the browser parses it to find all of the component objects such as images, sounds, scripts, etc., and then makes requests to download these objects from the website 115.

FIG. 3 shows details of the NIS 135 which is arranged, in this illustrative example, to collect and analyze network traffic through the mobile communications network 120 in order to make measurements of Internet usage by the users 105 of the network and mobile equipment 110. The NIS 135 is typically configured as one or more software applications or code sets that are operative on a computing platform such as a server 305 or distributed computing system. In alternative implementations, the NIS 135 can be arranged using hardware and/or firmware, or various combinations of hardware, firmware, or software as may be needed to meet the requirements of a particular usage scenario. As shown, network traffic typically in the form of IP packets 310 flowing through the mobile communications network 120, or a node of the network, is captured via a tap 315. A processing engine 320 takes the captured IP packets to make measurements of Internet usage 325 which can be typically written to one or more databases (representatively indicated by reference numeral 340) in common implementations.

As shown in FIG. 3, exemplary variables 330 that may be measured include page requests, visits, visit duration, search terms, entry page, landing page, exit page, referrer, click throughs, visitor characterizations, visitor engagements, conversions, hits, ad impressions, access times (time of day, day of week, etc.), the user's location (city, country, geo-location, etc.), and the like. It is emphasized that the exemplary variables shown in FIG. 3 are intended to be illustrative and that the number and particular variables that are utilized in any given application can differ from what is shown as required by the needs of a given application.

As shown in FIG. 4, the NIS 135 can be implemented, at least in part, using a deep packet inspection (DPI) machine 405. DPI machines are known and commercially available examples include the ixMachine produced by Qosmos SA. The IP packets 310 (FIG. 3) are collected in a packet capture component 440 of the DPI machine 405. An engine 445 takes the captured IP packets to extract various types of information, as indicated by reference numeral 450, and filter and/or classify the traffic, as indicated by reference numeral 455. An information delivery component 460 of the DPI machine 405 then outputs the data generated by the DPI engine 445. Software code may execute in a configuration and control layer 475 in the DPI machine 405 to control the DPI engine output and information delivery 460. In some implementations of the DPI machine 405, an API (application programming interface) (not shown in FIG. 4) can be specifically exposed to enable certain control of the DPI machine responsively to remote calls to the interface.

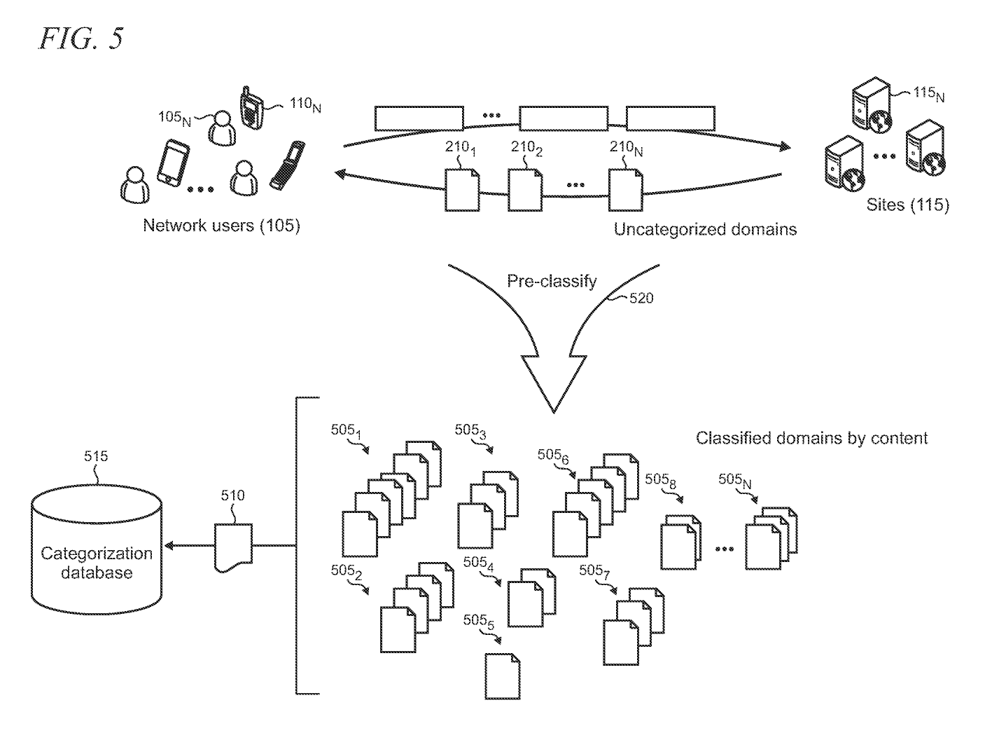

As shown in FIG. 5, in accordance with the present method for segmenting users of mobile Internet, domains supported by the websites 115 by network users 105 may be pre-classified by content into various pre-defined categories 505 to create a reference file 510 which may be stored in a categorization database 515, as indicated by arrow 520. That is, domains that share some given degree of similarity with respect to content will be populated into the same category. The number and types of categories utilized, the categorization criteria utilized, and the number of domains supporting the responses 210 populated into each category can typically be expected to vary by application. Accordingly, it is emphasized that the categories and number of constituent domains shown in FIG. 5 are illustrative only.

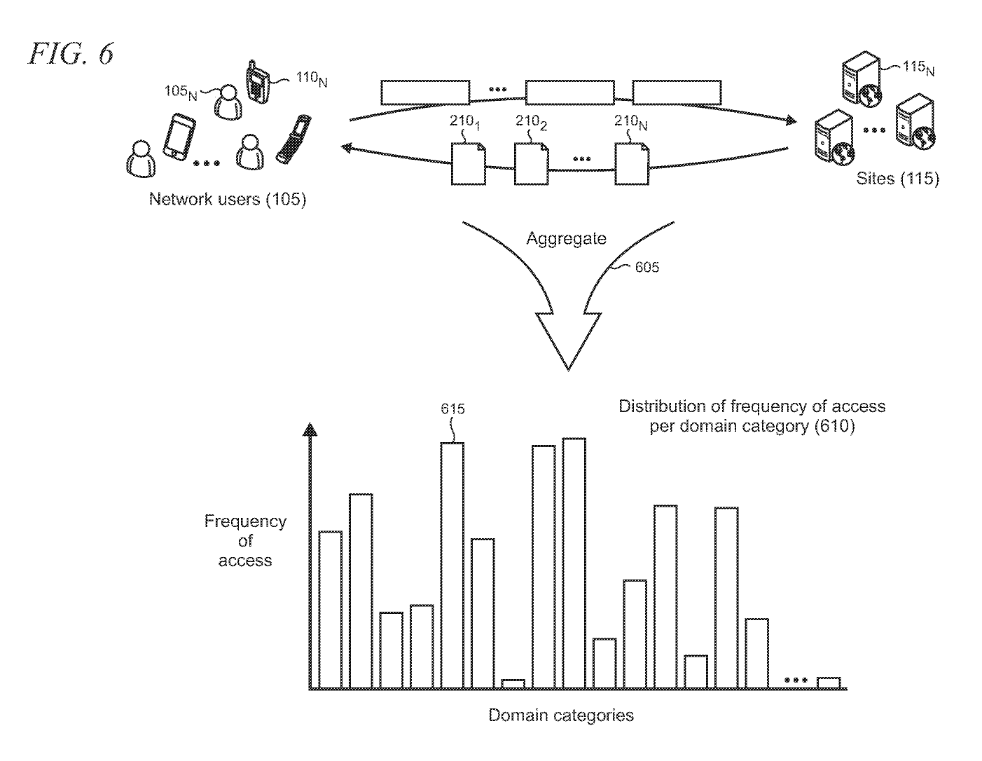

Mobile Internet access is monitored over some given time interval so that access to the domains which support the responses 210 by network users 105 can be aggregated by category, as indicated by arrow 605 in FIG. 6. Such aggregation enables the calculation of a distribution 610 that relates the frequency of access by the network user 105 to the categorized domains by category (where a representative category in the distribution 610 is indicated by reference numeral 615). As shown, some domain categories are more frequently accessed relative to other categories. However, it is emphasized that the distribution 610 that is illustrated in FIG. 6 is arbitrary and that the relative frequency of access in typical applications may vary from what is shown.

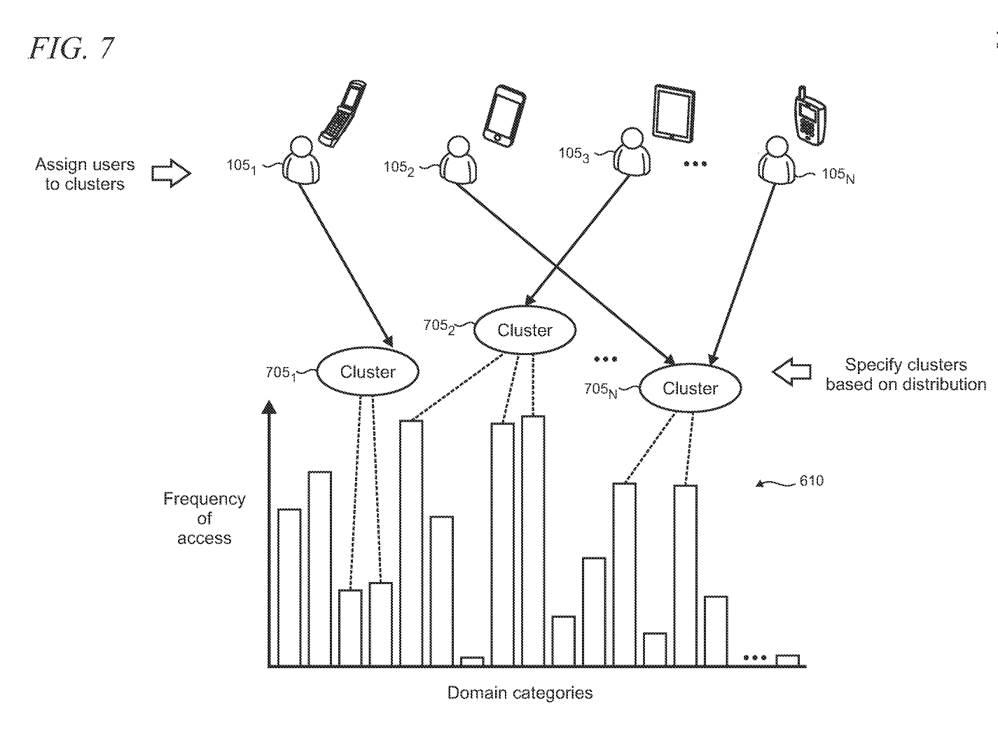

As shown in FIG. 7, each of the network users 105 is assigned to a cluster 705. Each cluster 705 will typically have multiple users 105 assigned to it, and users can be assigned to more than one cluster in some cases. The clusters 705 may comprise one or more domain categories and are specified, at least in part, using the calculated distribution 610 of frequency of user access to the categorized domains. Cluster analysis is a multivariate analysis technique that separates the component data into subgroups (i.e., “clusters”) of objects (e.g., domain categories) so that information about the whole set of n objects may be reduced to information about g subgroups, where g<n. For the sake of clarity in the illustration, only three illustrative clusters 705 are shown, however in many applications each of the domain categories in the distribution 610 will be a member of one or more clusters.

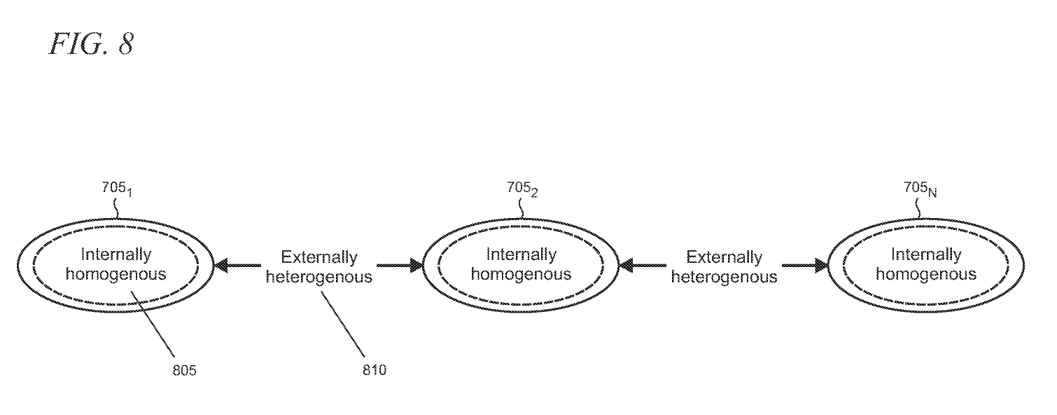

As shown in FIG. 8, clusters 705 are typically specified to achieve the goal that each cluster is highly internally homogenous, as representatively indicated by reference numeral 805. That is, objects within a cluster 705 are similar to each other. In this illustrative example, the similarity dimension is domain category access frequency. However, in alternative embodiments objects may be scored using several dimensions and then be clustered based on the similarity of such scores. Clusters are also typically specified to meet another goal of being highly externally heterogeneous, as representatively indicated by reference numeral 810 in FIG. 8. That is, clustered objects are not similar to objects in other clusters. The specific number of clusters 705 chosen to represent the whole set of n objects may vary by application. However, it will be appreciated that a given cluster solution may trade off efficiency in information reduction with object parsimony. In other words, using fewer clusters will decrease the homogeneity of the clustered objects while using more clusters will increase homogeneity.

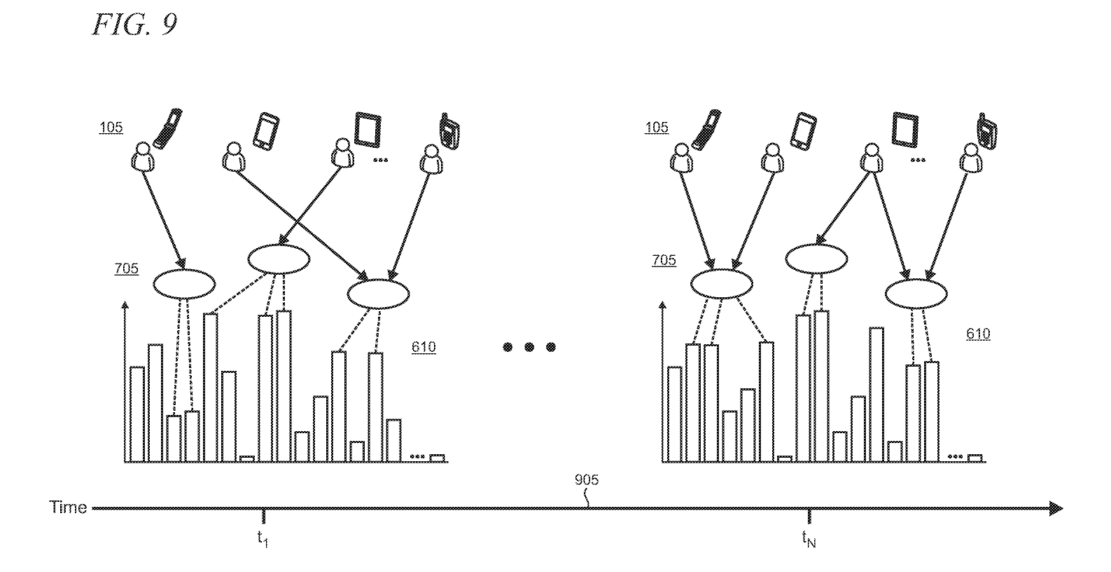

The assignment of users 105 to the cluster 705 may be performed in typical applications by observing the frequency of each user's access to the categorized domains over some observation time interval. Each user's observed access frequency can then be matched to the appropriate cluster so the goals of maximizing the internal homogeneity and external heterogeneity are achieved. As shown in FIG. 9, multiple instances of observing and cluster assigning may be implemented over a timeline 905. At a first interval beginning at time t₁, the frequency of access to categorized domains in the distribution 610 is observed and each user 105 is assigned to one or more clusters 705. At a subsequent interval beginning at time t_{N}, another set of observations and user assignments to clusters 705 are made. In some cases, the distribution 610 may be dynamically recalculated at one or more points on the timeline 905 and the clusters 705 re-specified prior to the user assignments to the clusters 705. The observations and assignments may also be performed iteratively based on user visits to websites over successive time intervals so that a time series of cluster assignments can be generated and utilized for additional analysis or reporting purposes. For example, a trend report may be prepared to show how mobile Internet users are dynamically segmented over some given time period.

The assignment of users 105 to clusters 705 may also optionally take into account additional criteria in some applications of the present arrangement. For example, such criteria may include information pertaining to the mobile equipment 110 (FIG. 1) that is used by the users to access the network and websites. Other criteria may also include, for example, the time of user access (e.g., time of day, day of week, etc.) and the user's location (e.g., city, country, geo-location, etc.) when accessing the network, and the like.

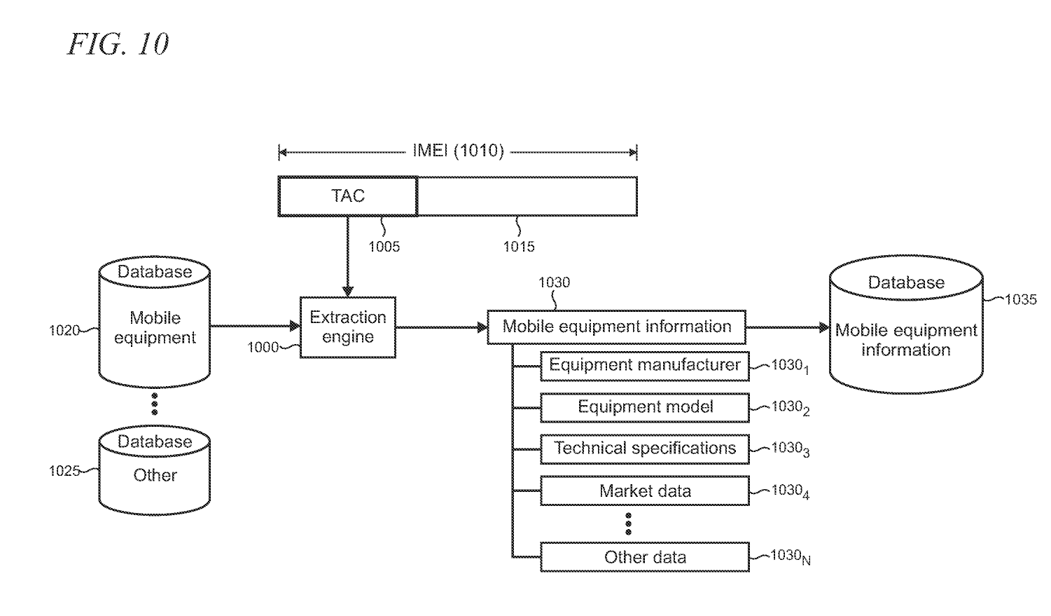

FIG. 10 shows application of an illustrative extraction engine 1000 that extracts the TAC 1005 portion of the IMEI (International Mobile Equipment Identity) 1010 to identify information pertaining to the mobile equipment 110 (FIG. 1) utilized in the mobile communications network environment 100. The IMEI and TAC are defined by the 3GPP (3^{rd} Generation Partnership Project) standard for mobile broadband under GSM (Global System for Mobile Communications). The mobile equipment 110 will typically transmit the IMEI to the mobile communications network 120 with each network access. The extraction engine may be disposed in the NIS 135 (FIG. 1) using portions or all of the functionality provided by the DPI machine 405 (FIG. 4) or implemented as standalone functionality in some instances.

It is noted that the TAC 1005 may be extracted from the IP packet stream 310 (FIG. 3) without extracting the entire IMEI 1010. Alternatively, various other portions of the IMEI, identified by reference numeral 1015 in FIG. 10, may be extracted along with TAC 1005. Under 3GPP, the TAC is currently the initial eight digits of the IMEI which itself is 14 digits plus a check digit or 16 digits for the IMEISV (IMEI Software Version). The TAC uniquely identifies the mobile equipment manufacturer and model. TAC databases or lookups exist and are available for remote access or, in some applications, a TAC database can be instantiated and maintained locally to the NIS 135. An illustrative mobile equipment database that includes mobile equipment lookups by TAC is represented in FIG. 10 by reference numeral 1020. The database 1020 may also include additional information beyond manufacturer and model of the mobile equipment. Alternatively, the information in database 1020 may be supplemented by one or more additional databases as representatively indicated by reference numeral 1025.

The extraction engine 1000 can thus take the TAC 1005 from the IP traffic to identify a variety of types and kinds of information about the particular mobile equipment 110 a given user 105 is utilizing to access the mobile communications network 120 (FIG. 1). As shown in FIG. 10, the mobile equipment information 1030 output from the extraction engine 1000 may include, for example, the mobile equipment manufacturer 1030₁; the model 1030₂ of the mobile equipment; various product specification criteria or technical specifications 1030₃ for the mobile equipment including features, capabilities and the like; market data 1030₄; and other data 1030_{N}. The market data 1030₄ could include, for example, information relating to sales volume of the particular mobile equipment (i.e., popularity), typical sales price for the mobile equipment, market share and growth rate, competitive mobile equipment, usage trends, and the like. Such market data may include other dimensions such as popularity by country/region, by user demographic—age, gender, household income, education, etc., by mobile carrier, etc. Accordingly, exemplary variables that may be used to characterize the mobile equipment information include manufacturer, model, equipment type/form-factor (e.g., smart phone, non-smart basic phone, physical keyboard-equipped, non-equipped, etc.), screen size and type (e.g., touchscreen, non-touchscreen), screen colors and resolution, operating system, mobile browser type, input/output (I/O) interfaces (e.g., Bluetooth compatibility), storage capacity, manufacturer-installed apps (applications), equipment features and capabilities (e.g., navigation, camera, memory card compatibility, WiFi enabled, etc.), equipment market share and growth (per country/region, per user demographic, etc.), sales volume and growth, average/typical equipment selling price, and the like. The analysis engine may typically write the results of the analysis (i.e., the mobile equipment information 1030) to a mobile equipment information database 1035.

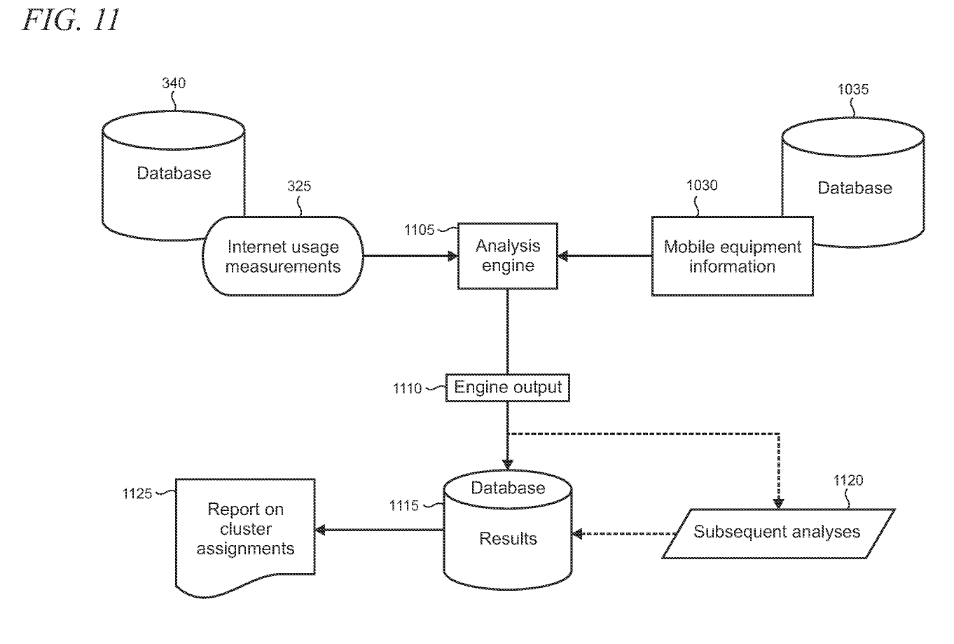

FIG. 11 shows use of an illustrative analysis engine 1105 for performing analyses of data including Internet usage measurements 325 and mobile equipment information 1030. The analysis engine 1105 may be configured to utilize the Internet usage measurements (e.g., access frequency, time of access, user location when making access) and mobile equipment information 1030 in various combinations, which may be weighted in some cases, as criteria that are applied when assigning network users to clusters (as shown in FIG. 7 and described in the accompanying text).

The analysis engine 1105 may be disposed in the NIS 135 (FIG. 1) using all or portions of the functionality provided by the DPI machine 405 (FIG. 4) or implemented as standalone functionality in some instances. The output 1110 from the analysis engine 1105 may be written to a results database 1115 or transmitted to a remote destination in some cases. Alternatively, subsequent analyses may be performed, as indicated by reference numeral 1120. Various reports such as a report on cluster assignments 1125 may be generated using data from the results database.

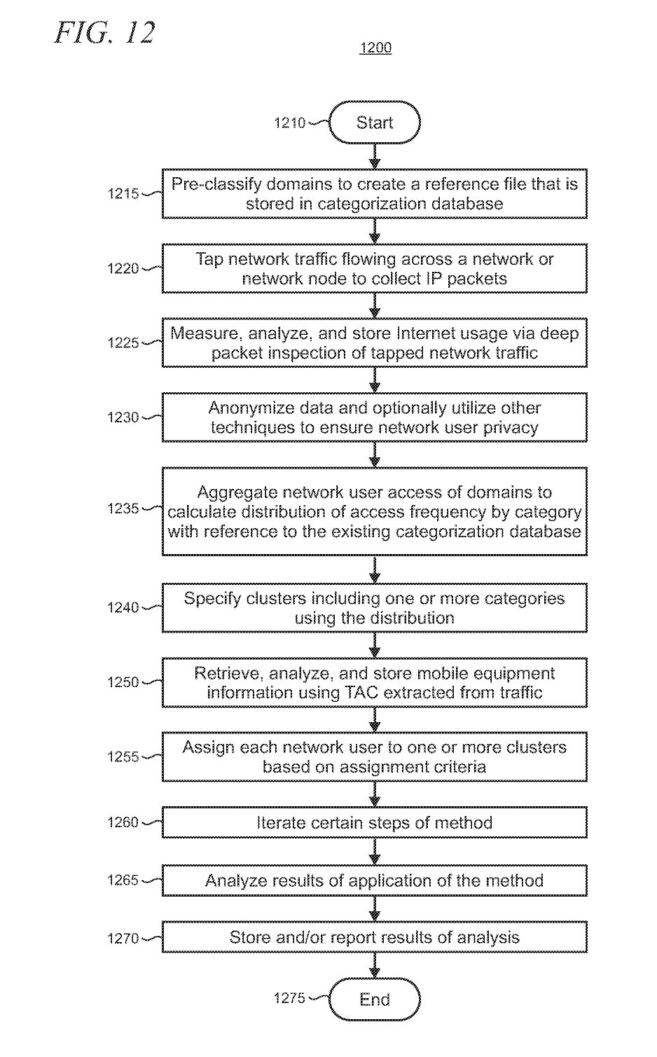

FIG. 12 shows a flowchart of an illustrative method 1200 for segmenting mobile Internet users. The method begins at block 1210. At block 1215, domains that are accessible by the mobile Internet users 105 (FIG. 1) are pre-classified into various pre-defined categories according to the type of content that is included in the domains. The classified domains may be stored as a reference file in a categorization database as shown in FIG. 5 and described in the accompanying text. At block 1220, traffic flowing across a network or network node is tapped to collect IP packets. At block 1225, Internet usage is measured, analyzed, and stored for the network users typically using deep packet inspection where exemplary metrics for the measurement and analysis are shown in FIG. 3 by reference numeral 330. At block 1230, data utilized by the NIS 135 (FIG. 1), or portions thereof may be anonymized to remove identifying information from the data, for example, to ensure that privacy of the network access device users is maintained. It is emphasized that while the method step in block 1230 is shown as occurring after block 1225, the anonymization described here may generally be included as part of the step shown in block 1225 or alternatively applied to the captured data at any point in the method 1200. End-user privacy may be preserved by irreversibly anonymizing all Personally Identifiable Information (PII) present in the extracted data. This anonymization takes into account both direct and indirect exposure of user privacy by applying a multitude of methods. Direct PII refers to names, numbers, and addresses that could as such identify an individual end-user, while indirect PII refers to the use of rare devices, applications, or content that could potentially identify an individual end-user.

Confidentiality of communications is fully respected and maintained in the present arrangement, as no private communications content is collected. More specifically, the majority of data is extracted from packet headers, and data from packet payloads is extracted only on specific cases where part of the payload in question is known to be public content, such as in the case of traffic sent in known format by known advertising servers. The data is collected by default on a census basis, but mechanisms for filtering in the data of opt-in end-users and filtering out the data of opt-out users are also supported.

At block 1235, the access to the classified domains by the network users is aggregated so that an access frequency distribution by domain category may be calculated. Using the distribution, clusters that encompass one or more categories may be specified at block 1240.

The step of method 1200 shown at block 1250 may be optionally utilized to provide additional criteria applied at the assigning step at block 1255. At block 1250, information about mobile equipment utilized by the network users 105 to access the classified domains may be received using the TAC that is extracted from the IP traffic at each network access. The mobile equipment information can include manufacturer, model, technical specifications, market data, and other data as shown in FIG. 10 and described in the accompanying text.

At block 1255 each network user 105 is assigned to one or more of the clusters 705 (FIG. 7) based on assignment criteria. The assignment criteria will typically comprise the frequency of access by the network users to the classified domains. Optionally, additional criteria including mobile equipment information and access time and location may also be utilized when assigning users to the clusters. As shown at block 1260, certain steps of the method 1200 may also be iterated in some applications. For example, observations about the users and cluster assignments may be performed repeatedly in order to create a time series of cluster assignments that may be utilized for analyzing trends in user behaviors.

The results of application of the method 1200 described above may be analyzed at block 1265. The results of the analysis may be stored or reported to remote locations at block 1270. The method ends at block 1275.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for segmenting users of mobile Internet, the method comprising the steps of:
classifying domains into pre-defined categories according to domain content, the domains being supported by Internet-based servers accessible from a mobile communications network;
aggregating access by the users to the classified domains to calculate a distribution of user access by category;
specifying a plurality of clusters using the distribution, each cluster encompassing one or more of the pre-defined categories; and
assigning each user to at least one cluster based at least on observations of the user's frequency of access to the classified domains.

2. The method of claim 1 in which the aggregating is performed using deep packet inspection of a tapped stream of IP traffic flowing between mobile equipment utilized by the users and the Internet-based servers.

3. The method of claim 2 in which the tapped stream of IP packets is subjected to anonymization to maintain privacy of the users.

4. The method of claim 1 in which the specifying comprises automatically generating clusters based on access homogeneity among candidates for inclusion within a cluster and heterogeneity across clusters.

5. The method of claim 2 in which the assigning is performed in further consideration of at least one additional criterion.

6. The method of claim 5 in which the additional criterion is one of time of access, user location, or information pertaining to mobile equipment utilized by the user to access the mobile communications network.

7. The method of claim 6 in which the mobile equipment is identified using a TAC extracted from the tapped stream of IP traffic.

8. The method of claim 1 in which the specifying comprises pre-defining each cluster based upon a relative frequency distribution across categories.

9. The method of claim 1 in which the assigning is performed iteratively based on user access to successive time intervals to generate a time series of cluster assignments.

10. The method of claim 9 including a further step of generating a report which includes the time series of cluster assignments.

11. A method for analyzing mobile Internet traffic, the method comprising the steps of:
accessing a database containing the traffic and corresponding behavior information collected for anonymized unique visits by mobile equipment users to domains on the mobile Internet over a first time interval;
defining a plurality of discrete categories of interests of the users; and
observing each of the users' relative frequency of access to domains corresponding to the categories over the first time interval; and
assigning each of the users to one or more clusters that encompass one or more of the categories.

12. The method of claim 11 further including a step of generating a report pertaining to distribution of users within each cluster.

13. The method of claim 11 in which the database further includes an indication of the mobile equipment and including a further step of associating information pertaining to the cluster with usage of the mobile equipment.

14. The method of claim 11 in which the mobile equipment comprises one of mobile phone, e-mail appliance, smart phone, non-smart phone, M2M equipment, PDA, PC, ultra-mobile PC, tablet device, tablet PC, handheld game device, digital media player, digital camera, GPS navigation device, pager, wireless data card, wireless dongle, wireless modem, or device which combines one or more features thereof.

15. The method of claim 11 further including the steps of accessing a database containing the traffic and corresponding behavior information collected for anonymized unique visits by mobile equipment users to domains on the mobile Internet over a second time interval, observing each of the users' relative frequencies of access to domains corresponding to the categories over the second time interval, and generating a trend report using observations made during the first and second time intervals.

16. A method for applying cluster analysis to Internet traffic flowing over a mobile communications network, the method comprising the steps of:
classifying domains accessible to network users over the Internet into n pre-defined categories, the classifying based on domain content;
observing Internet usage of the network users using the mobile communications network, the monitoring including tracking a frequency of access to the classified domains by the users;
specifying a plurality of g clusters, g<n, in which the specifying is performed in accordance with i) a target homogeneity for domains included in each cluster and ii) a target heterogeneity between clusters, criteria for inclusion of a category in a cluster being at least the frequency of access of a domain in the category; and
assigning each user to one or more of the clusters based on each user's observed frequency of access.

17. The method of claim 16 in which the observing is performed during web-browsing sessions.

18. The method of claim 16 in which the observing is performed by tapping IP traffic traversing a node of the mobile communications network and further including a step of performing deep packet inspection on the tapped IP traffic.

19. The method of claim 16 further including a step of implementing a timeline over which the steps of observing, specifying, and assigning are repeatedly dynamically performed.

20. The method of claim 16 in which the steps of observing, specifying, and assigning are performed substantially automatically in a network intelligence solution.
